(19) United States
(12) Patent Application Publication
(10) Pub. No.: US 2005/0280851 A1
(43) Pub. Date: Dec. 22, 2005

(54) Color signal processing method and apparatus usable with a color reproducing device having a wide color gamut

(76) Inventors: Moon-cheol Kim, Suwon-si (KR); Yoon-cheol Shin, Seoul (KR); Sang-jin Lee, Seoul (KR)

Correspondence Address: STANZIONE & KIM, LLP, 919 18TH STREET, N.W., SUITE 440, WASHINGTON, DC, 20006, US

(21) Appl. No.: 11/153,489

(22) Filed: Jun. 16, 2005

(30) Foreign Application Priority Data
Jun. 21, 2004 (KR) 2004-46082

(51) Int. Cl. H04N 1/60

(52) U.S. Cl. 358/1.9; 382/167; 358/518

(57) ABSTRACT

A color signal processing method includes calculating a mixing ratio for source primary colors of a color reproducing device through which an input color signal having standard primary colors is reproduced, mixing the source primary colors according to the calculated mixing ratio to obtain reconstructed primary colors, and transforming the input color signal to match a color gamut of the reconstructed primary colors and outputting the transformed color signal. Thus, the color gamut of the color reproducing device can be freely adjusted within a reproduction range thereof according to the input color signal.

### CROSS-REFERENCE TO RELATED APPLICATIONS

This application claims the benefit under 35 U.S.C. § 119 from Korean Patent Application No. 2004-46082, filed on Jun. 21, 2004, the content of which is incorporated herein by reference in its entirety.

### BACKGROUND OF THE INVENTION

1. Field of the Invention

The present general inventive concept relates to a color signal processing method and an apparatus thereof, and more particularly, to a color signal processing method and apparatus that can optimally set a color gamut reproducible by a color reproducing device according to an input color signal.

2. Description of the Related Art

In general, color reproducing devices, such as monitors, scanners, and printers, have their own color space and/or color model that are suitable for their respective application fields. For instance, color printing devices use a CMY color space, color CRT monitors or computer graphic devices use an RGB color space, and other devices use an HIS color space. Additionally, there are versatile CIE color spaces that can be applied to any type of device to define device-independent colors. Some examples of the CIE color spaces include CIE-XYZ, CIE L*a*b, and CIE L*u*v color spaces.

Even though different colors may be required depending on which color space they are used in, the color reproducing devices basically use three primary colors. For example, the RGB color space that is used in color CRT monitors or computer graphic devices is based on additive color mixtures of three primary colors including red, green, and blue. The CMY color space that is used in color image printers is based on three primary colors including cyan, magenta, and yellow. In recent years, there have been various attempts to extend a color gamut using four or more primary colors, e.g., MultiPrimary Display (MPD). Unlike conventional display devices that use three primary colors that correspond to three channels, the MPD uses more than four primary colors such that a band of color is wide and the color gamut can be extended.

The color gamut of a color reproducing device is defined by primary colors that are used in the color reproducing device. For example, as illustrated in FIG. 1, an area formed in the CIE-xy color space by connecting the primary colors that are used in the color reproducing device defines the color gamut of the corresponding color reproducing device. If the color reproducing device uses a first set primary colors P1, P2, and P3, the area of a triangle GAMUT1 defines the corresponding color gamut. Similarly, if the color reproducing device uses a second set of primary colors of P1′, P2′, and P3′, the area of a triangle GAMUT2 defines the color gamut of the color reproducing device.

However, a conventional color reproducing device that is used in a display device always expresses an input image with primary colors that are specified in Broadcast Standard or Color Signal Standard. Therefore, when using the MPD as the color reproducing device, a color gamut of an input color signal is narrower than a color gamut of the color reproducing device used for reproducing the input color signal. Thus, the color gamut of the color reproducing device is not fully utilized. In addition, a quantization error occurs in a color gamut mapping process between the input color signal and the color reproducing device. Furthermore, the application of a highly complicated algorithm used in the color gamut mapping process makes the color gamut mapping process difficult to implement in hardware.

### SUMMARY OF THE INVENTION

The present general inventive concept provides a color signal processing method and apparatus usable with a color reproducing device having a wide color gamut. The color signal processing method uses a simple algorithm and allows a color gamut that is reproducible by the color reproducing device to be optimally set according to an input color signal and/or other factors.

Additional aspects of the present general inventive concept will be set forth in part in the description which follows and, in part, will be obvious from the description, or may be learned by practice of the general inventive concept.

The foregoing and/or other aspects and advantages of the present general inventive concept may be achieved by providing a color signal processing method including: calculating a mixing ratio for source primary colors of a color reproducing device through which an input color signal having standard primary colors is reproduced, mixing the source primary colors according to the calculated mixing ratio to obtain reconstructed primary colors, and transforming the input color signal to match a color gamut of the reconstructed primary colors, and outputting the transformed color signal.

The method may further include converting chromaticity coordinates of the input color signal to chromaticity coordinates in a device independent color space, such as a CIE-XYZ color space, before calculating the mixing ratio. In this case, the input color signal may be received in an RGB color space, and the device independent color space may be the CIE-XYZ color space.

The foregoing and/or other aspects and advantages of the present general inventive concept may also be achieved by providing a color processing apparatus, including a primary color reconstructor to calculate a mixing ratio for source primary colors of a color reproducing device through which an input color signal having standard primary colors is reproduced and to mix the source primary colors according to the calculated mixing ratio to obtain reconstructed primary colors, and a color gamut mapping part to transform the input color signal to match a color gamut of the reconstructed primary colors and to output the transformed color signal.

The primary color reconstructor can calculate the mixing ratio according to a calorimetric display model using coordinates for the standard primary colors and corresponding white point tristimulus values and coordinates for the source primary colors. Additionally, the apparatus may further include a primary color storage to store the standard primary color coordinates and the corresponding white point tristimulus values thereof, and the source primary color coordinates and corresponding white point tristimulus values thereof, and a chromaticity coordinate conversion unit to convert chromaticity coordinates of the input color signal to color coordinates in a device independent color space and to provide the input color signal to the primary color reconstructor. The input color signal may be received in an RGB color space, and the device independent color space may be a CIE-XYZ color space.

The color reproducing device may comprise an MPD (MultiPrimary Display) that uses more than 4 primary colors. The color signal processing apparatus may be applied to the color reproducing device, such as a display device, to transform the input color signal and to reproduce a color.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a diagram illustrating a color gamut of a conventional color reproducing device;

FIG. 2 is a schematic block diagram illustrating a color signal processing apparatus to process a color signal according to an embodiment of the present general inventive concept;

FIG. 3 is a flow chart illustrating a method of processing a color signal according to an embodiment of the present general inventive concept;

FIG. 4 illustrates a display device that uses a color wheel;

FIG. 5 illustrates a method of processing a color signal in the display device of FIG. 4 according to an embodiment of the present general inventive concept;

FIG. 6 illustrates a display device that uses a free controllable light source; and

FIG. 7 illustrates a method of processing a color signal in the display device of FIG. 6 according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

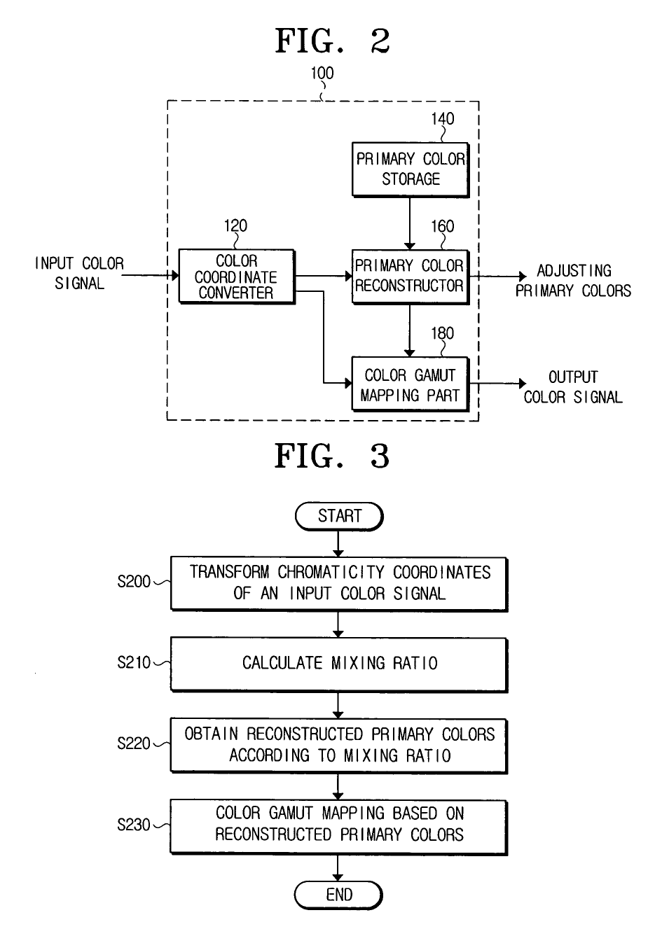

FIG. 2 is a schematic block diagram illustrating a color signal processing apparatus 100 according to an embodiment of the present general inventive concept. As illustrated in FIG. 2, the color signal processing apparatus 100 includes a color coordinate converter 120, a primary color storage 140, a primary color reconstructor 160, and a color gamut mapping part 180.

The color coordinate converter 120 transforms color coordinates of an input color signal to color coordinates in a device independent color space. The device independent color space may be a CIE-XYZ color space. Alternatively, other device independent color spaces may also be used. Here, input color signals are received in standard formats, such as National Television System Committee (NTSC), Phase Alternation by Line system (PAL), SMPTE-C, and sRGB of International Electro-Technical Commission (IEC). If the input color signal is non-linear, the color coordinate converter 120 converts the non-linear input color signal to a linear color signal through a linear correction process. The color coordinate converter 120 then converts chromaticity coordinates of the linear color signal to chromaticity coordinates of the device independent color space.

The primary color storage 140 stores standard primary color coordinates and white point tristimulus values that an input color signal uses, and source primary color coordinates and white point tristimulus values that a color reproducing device uses to reproduce the input color signal. The primary color reconstructor 160 calculates a mixing ratio to produce standard primary colors (i.e., primary colors of the input signal in the standard format) from a mixture of source primary colors of the color reproducing device. Then the primary color reconstructor 160 mixes the source primary colors of the color reproducing device according to the calculated mixing ratio to obtain reconstructed primary colors, and adjusts the source primary colors according to these reconstructed primary colors. The color gamut mapping part 180 transforms the input color signal to match a newly determined color gamut defined by the reconstructed primary colors, and outputs the transformed color signal. As described in further detail below, the various embodiments of the present general inventive concept can re-define (i.e., reconstruct) the color gamut of the color reproducing device by re-defining the source primary colors to represent the standard primary colors of the input color signals. In re-defining the color gamut of the color reproducing apparatus, the source primary colors of the color reproducing device can be mixed using channel light sources that are typically not used in conventional color reproducing devices. For example, the source primary colors can be mixed with each other by utilizing one or more spokes of a color wheel or by using more than one controllable color light source during a given color cycle. Thus, by mixing the source primary colors, the standard primary colors can be reproduced by the color reproducing device, which has a wide color gamut. Additionally, overall brightness and contrast can be improved by using the light sources that are typically not used in the conventional color reproducing devices (e.g., spokes or color lasers). This is described in more detail below.

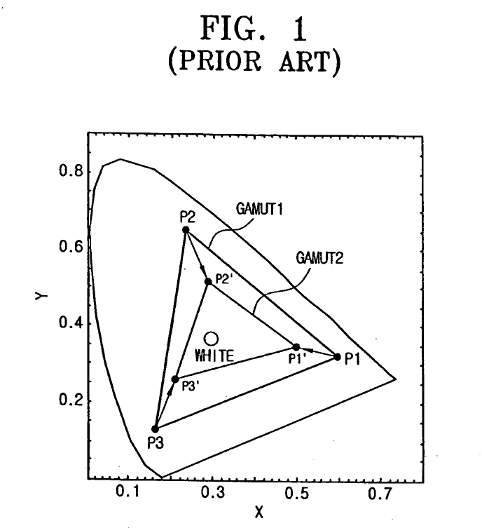

FIG. 3 is a flow chart illustrating a method of processing a color signal according to an embodiment of the present general inventive concept. P1′, P1′, and P3′ (FIG. 1) can be assumed to represent the standard primary colors of an input color signal and P1, P1, and P3 (FIG. 1) can be assumed to represent the source primary colors of the color reproducing device. The method of processing a color signal according to various embodiments of the present general inventive concept will now be described in more detail with reference to FIG. 1 to FIG. 3.

The color coordinate converter 120 transforms the color coordinates of the input color signal to the device independent CIE-XYZ color space (operation S200). As mentioned above, the input color signal can comply with the Broadcast Standard or Color Signal Standard. For description purposes, the input color signal is assumed to comply with the sRGB, which is a standard color space. However, it should be understood that other standard color spaces may also be used.

By utilizing color coordinates of the standard primary colors P1′, P2′, and P3′ and corresponding white point tristimulus values of the input color signal stored in the primary color storage 140, and chromaticity coordinates of the source primary colors P1, P2, and P3 and corresponding white point tristimulus values of the color reproducing device, the primary color reconstructor 160 calculates the mixing ratio to produce the standard primary colors P1′, P2′, and P3′ from the mixture of the source primary colors P1, P2, and P3 (operation S210). Accordingly, the primary color reconstructor 160 obtains reconstructed primary colors according to the calculated mixing ratio (operation S220). More details about these operations are provided below.

If the color gamut of the color reproducing device is represented by GAMUT1 illustrated in FIG. 1, a chromaticity coordinate matrix Ps of the source primary colors of the color reproducing device includes P1 (xᵣᵣ, yᵣᵣ, Zᵣᵣ), P2(x_{gg}, y_{gg}, z_{gg}), P3(X_{bb}, Y_{bb}, Z_{bb}), and the corresponding white point tristimulus values are Fws=(X_{ws}, Y_{ws}, Z_{ws}). Thus, a colorimetric display model can be expressed by Equation 1 below.

$${F}_{S}^{T} = Ms \cdot {( R , G , B )}^{T} = {P}_{S} \cdot {N}_{S} \cdot {( R , G , B )}^{T} \\ {P}_{S} = ( \begin{matrix}{x}_{rr} {x}_{gg} {x}_{bb} \\ {y}_{rr} {y}_{gg} {y}_{bb} \\ {z}_{rr} {z}_{gg} {z}_{bb}\end{matrix} ) , {N}_{S} = ( \begin{matrix}{N}_{r} 00 \\ 0 {N}_{g} 0 \\ 00 {N}_{b}\end{matrix} ) , {M}_{S} = ( \begin{matrix}{X}_{rr} {X}_{gg} {X}_{bb} \\ {Y}_{rr} {Y}_{gg} {Y}_{bb} \\ {Z}_{rr} {Z}_{gg} {Z}_{bb}\end{matrix} ) \qquad [ Equation 1 ]$$

In Equation 1, when R=G=B=1 (i.e., white), a normalization matrix Ns is determined to make Fs=Fws. A red primary vector Frs=(xᵣᵣ, yᵣᵣ, zᵣᵣ) becomes tristimulus values of a red color that is reproduced when (R, G, B)=(1, 0, 0). In a similar manner, a green primary vector Fgs=(x_{gg}, y_{gg}, z_{gg}) becomes tristimulus values of a green color that is reproduced when (R, G, B)=(0, 1, 0), and a blue primary vector Fbs=(X_{bb}, Y_{bb}, Z_{bb}) are tristimulus values of a blue color that is reproduced when (R, G, B)=(0, 0, 1). Therefore, the color gamut of the color reproducing device Fs is defined in Equation 1.

Similarly, when the color gamut of the input color signal is represented by GAMUT2 as illustrated in FIG. 1, a chromaticity coordinate matrix Pt of the standard primary colors of the input color signal includes P1′(xᵣₜ, yᵣₜ, Zᵣₜ), P2′(x_{gt}, Y_{gt}, Z_{gt}), P3′(x_{bt}, Y_{bt}, Z_{bt}), and the corresponding white point tristimulus values are Fwt=(X_{wt}, Y_{wt}, Z_{wt}) Thus, a colorimetric display model from the standard primary colors can be expressed by Equation 2 below.

$${F}_{t}^{T} = {M}_{t} \cdot {( R , G , B )}^{T} = {P}_{t} \cdot {N}_{t} \cdot {( R , G , B )}^{T} \\ {P}_{t} = ( \begin{matrix}{x}_{rt} {x}_{gt} {x}_{bt} \\ {y}_{rt} {y}_{gt} {y}_{bt} \\ {z}_{rt} {z}_{gt} {z}_{bt}\end{matrix} ) , {N}_{t} = ( \begin{matrix}{N}_{rt} 00 \\ 0 {N}_{gt} 0 \\ 00 {N}_{bt}\end{matrix} ) , {M}_{t} = ( \begin{matrix}{X}_{rt} {X}_{gt} {X}_{bt} \\ {Y}_{rt} {Y}_{gt} {Y}_{bt} \\ {Z}_{rt} {Z}_{gt} {Z}_{bt}\end{matrix} ) \qquad [ Equation 2 ]$$

As described in Equation 2, a normalization vector Nt can be obtained from standard white points. Similarly, a standard red vector Frt=(xᵣₜ, yᵣₜ, zᵣₜ), a standard green vector Fgt=(x_{gt}, y_{gt}, z_{gt}), and a standard blue vector Fbt=(x_{bt}, Y_{bt}, Z_{bt}) become the corresponding tristimulus values.

From the vectors of source primary colors (Frs, Fgs, Fbs), vectors of standard primary colors (Frt, Fgt, Frt) satisfying Equation 2 can be obtained as follows.
Fᵣₜ=kᵣᵣ·Fᵣₛ+k_{gr}·F_{gs}+k_{br}·F_{bs}
F_{gt}=k_{rg}·Fᵣₛ+k_{gg}·F_{gs}+k_{bg}F_{bs}
F_{bt}=k_{rb}·Fᵣₛ+k_{gb}·F_{gs}+k_{bb}·F_{bs} [Equation 3]

Equation 3 can be rewritten as Equation 4 below.

$$( {F}_{rt} {F}_{gt} {F}_{bt} ) = ( {F}_{rs} {F}_{gs} {F}_{bs} ) \cdot ( \begin{matrix}{k}_{rr} {k}_{rg} {k}_{rb} \\ {k}_{gr} {k}_{gg} {k}_{gb} \\ {k}_{br} {k}_{bg} {k}_{bb}\end{matrix} ) = ( {F}_{rs} {F}_{gs} {F}_{bs} ) \cdot G \\ G = ( \begin{matrix}{k}_{rr} {k}_{rg} {k}_{rb} \\ {k}_{gr} {k}_{gg} {k}_{gb} \\ {k}_{br} {k}_{bg} {k}_{bb}\end{matrix} ) \qquad [ Equation 4 ]$$

Therefore, a matrix G to produce standard primary colors P1′, P2′, and P3′ in Equation 4 becomes the mixing ratio of source primary colors P1, P2, and P3 of the color reproducing device. However, in some cases a major signal in the matrix G (i.e., a diagonal component (kᵣᵣ, k_{gg}, k_{bb})) can be less than a maximum value ‘1’. Thus, in order to maximize a brightness of the color gamut determined by standard primary colors P1′, P2′, and P3′, the matrix G should be normalized by being divided by N=Max (kᵣᵣ, k_{gg}, k_{bb}) as follows.
Gn=G/N [Equation 5]

Producing the standard primary colors P1′, P2′, and P3′ from the source primary colors P1, P2, and P3 is accomplished by adjusting a quantity of light of each channel light source by a corresponding coefficient of the Gn matrix. Once the quantity of light of each channel light source is adjusted, the color gamut mapping part 180 transforms the input color signal by using the following equation to match the input color signal with the color gamut determined by the reconstructed source primary colors (operation S230), and outputs the transformed color signal.

$$( \begin{matrix}{R}^{′} \\ {G}^{′} \\ {B}^{′}\end{matrix} ) = {M}_{t}^{- 1} \cdot {M}_{s} ( \begin{matrix}R \\ G \\ B\end{matrix} ) \qquad [ Equation 6 ]$$

The color signal processing apparatus 100 of the embodiments of the present general inventive concept is capable of transforming the color gamut of the color reproducing device according to the standard primary colors of an input color signal. Although the various embodiments of the present general inventive concept described above reconstruct the source primary colors with reference to the color gamut of the input color signal, the color gamut that includes the reconstructed source primary colors can be arbitrarily determined according to corresponding applications. Accordingly, the color gamut of the color reproducing device can be arbitrarily determined, and residual light can be utilized. As a result, an image that is reproduced features an improved brightness and contrast. These advantages are magnified when the color reproducing device is adapted to a particular display. This is described below.

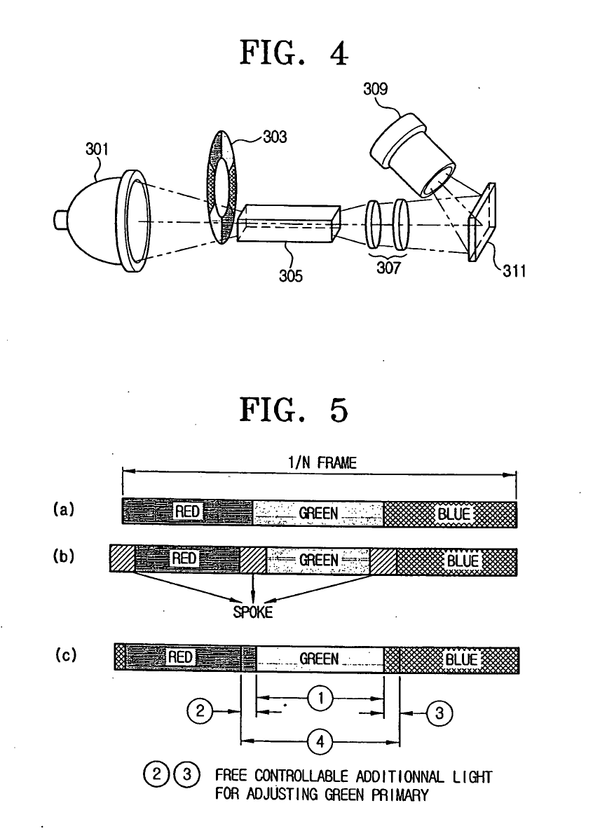

FIG. 4 illustrates a DLP projection display device (e.g., RGB 3-channel) that uses a color wheel. As illustrated in FIG. 4, the DLP projection display device includes a lamp 301, a color wheel 303, a light pipe 305, an illumination optical system 307, a projection optical system 309, and a Digital Mirror Device (DMD) 311.

A light spectrum of the lamp 301 is split into three primary colors (e.g., RGB) by the rotary color wheel 303. The split colors are then emitted to the DMD 311 via the light pipe 305 and the illumination optical system 307, and are synchronized with an image signal applied to each pixel of the DMD 311. Finally, color signals that are synchronized with the image signal are projected onto a screen through the projection optical system 307.

FIG. 5 illustrates a method of processing a color signal in the DLP projection display device of FIG. 4 according to an embodiment of the present general inventive concept. In particular, a view (a) illustrates operation of a color wheel; a view (b) illustrates a conventional method of processing a color signal using a color wheel; and a view (c) illustrates a method of processing a color signal using a color wheel according to an embodiment of the present general inventive concept. As illustrated in the view (a) of FIG. 5, an RGB color cycle is approximately 1/n*16 ms, given that a color wheel generally rotates n times per video frame. Other color cycles and/or color wheel types may be used with the present general inventive concept. In the conventional method of processing a color signal illustrated in the view (b) of FIG. 5, a SPOKE section is not used. A beam spot that passes through the color wheel 303 is not an exact point, and as a result, two adjacent colors on a boundary between two neighboring color segments of the color wheel are often mixed causing deterioration of purity of primary colors of the color wheel. Since the conventional method of processing the color signal using the color wheel does not use the SPOKE section, the quantity of light is reduced.

The color signal processing method according to the present embodiment of the general inventive concept, however, utilizes the SPOKE section as illustrated in the view (c) of FIG. 5. Referring back to FIG. 1, the color gamut defined by the source primary colors of the display device is represented by GAMUT1, and the color gamut defined by the standard primary colors of an input image that corresponds to the input color signal is represented by GAMUT2. As illustrated in FIG. 5, in a green (G) primary color segment, for example, a color expressed by section 1 corresponds to P2 of FIG. 1, a color expressed by section 4 corresponds to P2′, and two other colors expressed by sections 2 and 3, respectively, correspond to P1 and P3 of FIG. 1. Section 1 corresponds to a coefficient of green color of the matrix Gn in Equation 5. In other words, the length of section 1 is k_{gg}, the length of section 2 that is mixed with section 1 is k_{rg}, and the length of section 3 that is mixed with section 1 is k_{bb}. That is, sections 2 and 3 (P1 and P3) are mixed into section 1 (P2) to obtain P2′ according to the lengths of corresponding mixing areas indicated by coefficients of the matrix Gn. The use of the SPOKE section naturally increases the quantity of light for use in the display device.

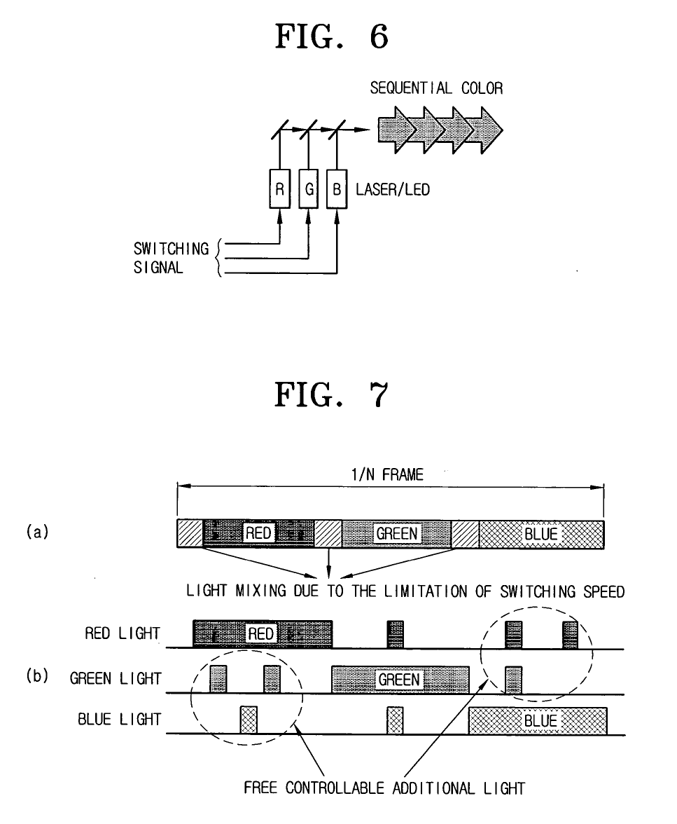

FIG. 6 illustrates a display device that uses a free controllable light source, such as a laser or LED, instead of the lamp 301 of the display device of FIG. 4. The display device of FIG. 6 is different from that of FIG. 4 in that it uses a laser as a light source and controls the laser using a switching signal.

FIG. 7 illustrates a method of processing a color signal in the display device of FIG. 6 according to an embodiment of the present general inventive concept. In particular, a view (a) of FIG. 7 illustrates a conventional method of processing a color signal, and a view (b) of FIG. 7 illustrates a method of processing a color signal according to an embodiment of the present general inventive concept. The display device of FIG. 6 can obtain the same effects described above, by mixing other primary colors during a main period of a particular primary color specified by a Broadcast Standard or Color Signal Standard. For example, the laser device may operate a blue laser and a red laser for a predetermined amount of time during a green color period to transform the source primary color green P2 to a corresponding reconstructed primary color P2′.

While the various embodiments of the present general inventive concept describe 3-channel display devices, it should be understood that the present general inventive concept may be used with a Multiprimary Display (MPD) that utilizes 4 or more primary colors. In addition, the method of processing color signals according to the various embodiments of the present general inventive concept can also be utilized in display devices using diverse micro display panels, as well as a DMD. Furthermore, the method of processing color signals can be implemented in hardware, software, or a combination thereof. For example, the method of processing color signals can be programmed and executed in a computer using computer readable media containing executable code therein.

In light of the foregoing, the various embodiments of the present general inventive concept make it possible to freely adjust a color gamut of a color reproducing device within a reproduction range thereof. In effect, the color gamut of the color reproducing device can be arbitrarily determined according to an input color signal. By presenting a relatively simple algorithm, the present general inventive concept makes color signal processing easier, and allows a variety of color gamuts to be adjusted and used without causing quantization error.

The foregoing embodiment and advantages are merely exemplary and are not to be construed as limiting the present general inventive concept. The present teachings can be readily applied to other types of apparatuses. Also, the description of the embodiments of the present general inventive concept is intended to be illustrative, and not to limit the scope of the claims, and many alternatives, modifications, and variations will be apparent to those skilled in the art. Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A color signal processing method, the method comprising:
calculating a mixing ratio for source primary colors of a color reproducing device through which an input color signal having standard primary colors is reproduced;
mixing the source primary colors according to the calculated mixing ratio to obtain reconstructed primary colors; and
transforming the input color signal to match a color gamut of the reconstructed primary colors and outputting the transformed color signal.

2. The method according to claim 1, wherein the calculating of the mixing ratio comprises calculating the mixing ratio according to a calorimetric display model using coordinates for the standard primary colors and corresponding white point tristimulus values, and coordinates for the source primary colors.

3. The method according to claim 1, further comprising:
before calculating the mixing ratio, converting color coordinates of the input color signal to chromaticity coordinates in a device independent color space.

4. The method according to claim 3, wherein the input color signal is received in an RGB color space, and the device independent color space is a CIE-XYZ color space.

5. A method of processing color signals usable with a display device, the method comprising:
receiving an input video having a plurality of input primary colors defining an input color gamut;
determining a combination of source primary colors of a display device color gamut to represent the plurality of input primary colors;
converting the display device color gamut to represent the plurality of input primary colors; and
outputting an output video that corresponds to the input video according to the converted color gamut.

6. The method according to claim 5, wherein the plurality of input primary colors are received in a standard color space.

7. The method according to claim 5, wherein the converting of the display device color gamut to the converted color gamut comprises reducing a color range size of the display device color gamut to match the input color gamut such that remaining luminance not being used to represent colors in the display device color gamut is used to increase luminance of colors of the converted color gamut.

8. The method according to claim 5, wherein the outputting of the output video comprises mapping the input primary colors that define the input color gamut to colors in the converted color gamut by operating a brightness source in the display device that is unused when outputting colors in the input color gamut and is used when reproducing colors in the display device color gamut.

9. The method according to claim 8, wherein the mapping of the input primary colors that define in the input color gamut comprises determining one or more brightness adjustment ratios to define the input primary colors from the source primary colors using the unused brightness source and a used brightness source of the display device.

10. The method according to claim 9, wherein the display device comprises a color wheel having one or more spokes, and the unused brightness source comprises the one or more spokes of the color wheel that are mixed with the source primary colors that define the display device color gamut.

11. The method according to claim 9, wherein the unused brightness source comprises one or more secondary color lasers that are mixed with a color that is produced by a primary color laser.

12. The method according to claim 5, wherein the converted color gamut includes colors that are omitted from the display device color gamut but that are not present in the input video.

13. The method according to claim 12, wherein light used to express the omitted colors in the display device color gamut is used to supply additional luminance for colors in the converted color gamut.

14. The method according to claim 5, wherein the receiving of the input video comprises receiving the input video in a predetermined color space and converting color signals of the input video from the predetermined color space to a device independent color space.

15. A color processing method usable with a color display device, the method comprising:
receiving an input color signal having a first gamut defined by standard primary colors;
processing a second gamut that corresponds to the color display device having source primary colors and the first gamut to form a third gamut capable of representing the standard primary colors using the source primary colors; and
outputting an output color signal that corresponds to the input color signal according to the third gamut.

16. The method according to claim 15, wherein the second gamut is wider than the first gamut.

17. The method according to claim 16, wherein a luminance of the color display device used to produce colors in the second gamut that are not present in the third gamut is used to increase luminance of all colors in the third gamut.

18. The method according to claim 15, wherein the number of the source primary colors is greater than the number of standard primary colors.

19. A method of processing a color signal in a digital light processing (DLP) unit, the method comprising:
defining a reproducible color range of the DLP unit according to a first input color signal having first primary colors;
receiving a second input color signal having second primary colors; and
re-defining the reproducible color range of the DLP unit according to the second input color signal having the second primary colors.

20. The method according to claim 19, further comprising:
determining a color mapping ratio to apply to the DLP unit to adjust luminances of a plurality of parts of the DLP unit to produce the second primary colors from source primary colors of the DLP unit; and
determining a representation of the second color signal using the source primary colors and outputting the second color signal according to the determined representation and the determined mapping ratio.

21. The method according to claim 20, wherein the determining of the color mapping ratio comprises adjusting luminances of a plurality of color segments of a color wheel and luminances of one or more spokes of the color wheel.

22. A method of processing a color signal usable with a display device having a display device color range, the method comprising:
receiving an input color signal having a standard color range; and
determining a mixing ratio to mix source primary colors that define the display device color range to represent standard primary colors that define the standard color range using a reconstructed color range,
wherein the mixing ratio comprises a plurality of mixing coefficients that indicate an amount of mixing between each of the source primary colors to form each of a plurality of reconstructed primary colors that define the reconstructed color range.

23. The method according to claim 22, further comprising:
outputting an output color signal in the reconstructed color range according to:
$$( \begin{matrix}{R}^{′} \\ {G}^{′} \\ {B}^{′}\end{matrix} ) = {M}_{t}^{- 1} \cdot {M}_{s} ( \begin{matrix}R \\ G \\ B\end{matrix} )$$
where (R′G′B′)^{T} represents the output color signal in the reconstructed color range, (RGB)^{T} represents the input color signal in the standard color range, Ms represents a first product of a first matrix that defines the source primary colors and a second normalized matrix that is obtainable from white point values of the source primary colors, and Mt⁻¹ represents an inverse of a second product of a third matrix that defines the standard primary colors and a fourth matrix that is obtainable from white point values of the standard primary colors.

24. The method according to claim 22, wherein the reconstructed color range is obtainable by multiplying the mixing ratio by the display device color range.

25. The method according to claim 22, wherein the plurality of reconstructed primary colors has a 1:1 correspondence with the standard primary colors.

26. The method according to claim 22, wherein the reconstructed color range is a more luminant representation of the standard color range.

27. The method according to claim 22, wherein the plurality of reconstructed primary colors each is formed using a plurality of different color light sources.

28. The method according to claim 22, wherein a correspondence between the standard primary colors and the source primary colors is not 1:1.

29. A color processing apparatus, comprising:
a primary color reconstructor to calculate a mixing ratio for source primary colors of a color reproducing device through which an input color signal having standard primary colors is reproduced and to mix the source primary colors according to the calculated mixing ratio to obtain reconstructed primary colors; and
a color gamut mapping part to transform the input color signal to match a color gamut of the reconstructed primary colors and to output the transformed color signal.

30. The apparatus according to claim 29, wherein the primary color reconstructor calculates the mixing ratio according to a calorimetric display model using coordinates for the standard primary colors and corresponding white point tristimulus values, and coordinates for the source primary colors.

31. The apparatus according to claim 30, further comprising:
a primary color storage to store the standard primary color coordinates and the corresponding white point tristimulus values thereof, and the source primary color coordinates and corresponding white point tristimulus values thereof.

32. The apparatus according to claim 29, further comprising:
a chromaticity coordinate conversion unit to convert chromaticity coordinates of the input color signal to chromaticity coordinates in a device independent color space and to provide the input color signal having the converted chromaticity coordinates to the primary color reconstructor.

33. The apparatus according to claim 32, wherein the input color signal is received in an RGB color space, and the device independent color space is a CIE-XYZ color space.

34. The apparatus according to claim 29, wherein the color reproducing device comprises an MPD (MultiPrimary Display) that uses more than 4 primary colors.

35. The apparatus as claimed in claim 29, wherein the color reproducing device transforms the input color signal value to reproduce a color using the color processing apparatus.

36. A computer readable medium containing executable code to process a color signal, the medium comprising:
a first executable code to calculate a mixing ratio for source primary colors of a color reproducing device through which an input color signal having standard primary colors is reproduced;
a second executable code to mix the source primary colors according to the calculated mixing ratio to obtain reconstructed primary colors; and
a third executable code to transform the input color signal to match a color gamut of the reconstructed primary colors and to output the transformed color signal.
